(19) United States
(12) Patent Application Publication
(10) Pub. No.: US 2002/0033970 A1
(43) Pub. Date: Mar. 21, 2002

(54) Apparatus and method for directly activating an application for editing information of an image after format conversion

(76) Inventor: Frank Chen, Taichung (TW)

Correspondence Address: BACON & THOMAS, PLLC, 4th Floor, 625 Slaters Lane, Alexandria, VA, 22314-1176, US

(21) Appl. No.: 09/796,628

(22) Filed: Mar. 2, 2001

(30) Foreign Application Priority Data
Sep. 16, 2000 (TW) 89119047

(51) Int. Cl. H04N 1/46; H04N 1/40

(52) U.S. Cl. 358/445; 358/537

(57) ABSTRACT

An apparatus and method for a scanner or a digital still camera that activating an application for editing information of images after file conversion by means of one touch action performed in scanner or digital still camera is disclosed. Individual may activate a scanner or digital still camera to generate images by means of one touch action. Those generated images may be forwarded to a computer system. Image file formats are converted into the ones suitable for the application assigned for editing. Those converted files are then loaded by the employed application for editing. An operation of assignment to an application mounted in the computer system for editing images may be optionally employed in the embodiment.

### BACKGROUND OF THE INVENTION

1. Field of the Invention

The present invention relates to an apparatus and method for editing information provided by images. More particularly, the present invention relates to an apparatus and method, which activates an application for editing information of images provided by a scanner or a digital still camera after format conversion, by means of one touch action performed in scanner or digital still camera.

2. Description of the Prior Art

Advancements in the electrical engineering makes the functions and performance provided by computer peripheral devices to keep increasing exponentially. For example, engineers who are skilled in manufacturing scanners or digital still cameras (DSCs) should unceasingly upgrade scan resolutions and color display performance. They should have to enable their products to activate printers to copy scanned images or to fax the scanned ones to destinations indicated by individual via computer systems. However, conventional scanners or DSCs usually define a button as a unique function, such as enabling scanning, copying, or faxing operations in a scanner, while a DSC may define its buttons to respectively perform shoot or playback operation. Individual may activate those functions by pressing associated buttons.

Conventionally, individual should turn on scanner power and make the scanner to successfully connect with a computer system before enabling associated scan operation by pressing pre-defined scan button in scanner or via graphic interfaces provided by scanner manufacturers displayed in the screen of the computer system. Scanned images should be forwarded to the computer system via a connection, therefore individual may perform further operations such as optical character recognition, activating applications for editing the scanned images, or even activating a browser to upload the scanned images to web sites indicated by individual. Individual obviously has to perform a plurality of operating sequences before achieving his or her requirements. Similarly, for those users of DSCs, all shot pictures should be stored in DSC before forwarding to a computer system for further image processing or editing, he or she obviously has to perform a plurality of operating sequences before editing shot images. Additionally, a scanner manufacturer usually provides powerful operating interfaces for controlling various scanner operations. For those persons who are unfamiliar with computer systems, they usually confuse by those powerful interfaces and find no way to obtain entrances for enabling required operations. There is a need to disclose a more convenient operation way accompanied with friendly interfaces that the aforementioned disadvantages of the conventional approaches should be completely eliminated.

### SUMMARY OF THE INVENTION

The principal object of the present invention is to provide an apparatus and method that activates an application for editing information of images provided by a scanner or a digital still camera after file conversion by means of one touch action performed in scanner or digital still camera.

In one embodiment, images generated by a scanner or digital still camera (DSC) are routed to a computer system for converting file formats before loading to assigned application for information editing. Individual may assign the application that loads the files after format conversion from images before activating one touch action in scanner side for capturing images. A DSC may shoot and store pictures or images when off-line with the computer system. The stored pictures or images may be forwarded to the computer system coupled with the DSC and then loaded by the preassigned application for editing. Any application which operates text editing or images processing, or an application for playing music (such as MP3) or translating between different languages may be employed in the embodiment.

In the embodiment, a scan or DSC resident module is mounted in the computer system, which further includes a command interpretation module, a command-encoding module, a user interface resource module, a computer resource inquisition module, and a connection status detection module. Command interpretation module stores programs operated by the processing device of the computer system to perform operations of interpreting commands input from the scanner, DSC, or computer system. Command-encoding module stores programs operated by the processing device of the computer system to perform operations of encoding commands for further forwarding to the scanner or DSC for scanning or shooting, or to transfer the generated image to the computer system. User interface resource module stores resource codes associated with graphics or icons required by the graphic interfaces. Computer resource inquisition module stores programs operated by the processing device of the computer system to perform the operation such as inquiring the currently mounted applications of the computer system. Connection status detection module stores programs operated by the processing device of the computer system to perform the operation such as monitoring the connection status between the scanner and computer system. Associated operations will be performed when the processing device of the computer system operates the programs or codes provided by the aforementioned modules.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is a schematic diagram of the preferred embodiment according to the present invention;

FIG. 1B is an exemplary diagram for illustrating an input device of the scanner in the embodiment;

FIG. 2 is a configuration module of a scan resident module in the embodiment;

FIG. 3A is a diagram illustrating an exemplary graphic interface when individual enables associated scan operation in the embodiment;

FIG. 3B is a diagram illustrating an exemplary graphic interface when individual enables associated fax operation in the embodiment;

FIG. 3C is a diagram illustrating an exemplary graphic interface when individual enables a composite button for activating functions included inside in the embodiment;

FIG. 3D is a diagram illustrating an exemplary graphic interface when individual enables a SCAN-TO-AP button in the embodiment;

FIG. 3E is a diagram illustrating an exemplary graphic interface provided for individual to vary or assign an employed application in the embodiment; and

FIG. 4 is a flowchart for illustrating operating sequences of the embodiment.

### DESCRIPTION OF THE PREFERRED EMBODIMENT

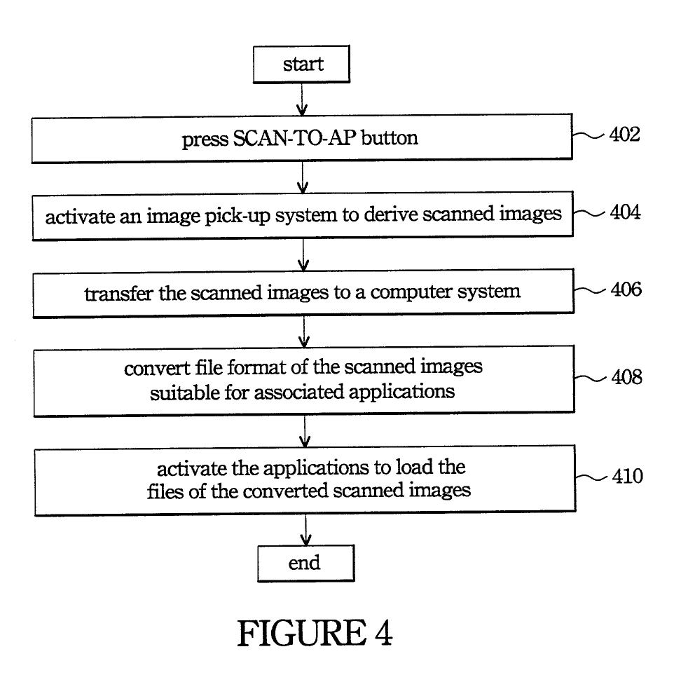

Please firstly refer to FIG. 4, a flowchart illustrative of operating sequences of the embodiment is shown therein. When individual presses a button in scanner or DSC side that is designed for directly activating associated application (step 402) for information editing after format conversion, commands indicated by the pressed button will activate the scanner or DSC for scanning or shooting images (step 404). Those generated images will be forwarded to a computer system coupled with the scanner or DSC (step 406), while the computer system converts image file formats suitable for the assigned applications (step 408). The assigned application is then activated to load the converted files for editing information provided by the images (step 410).

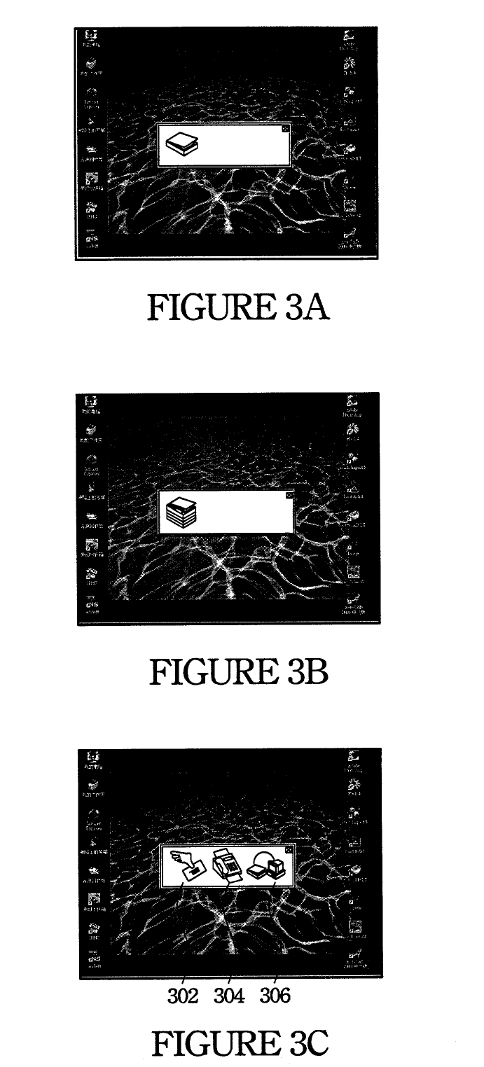

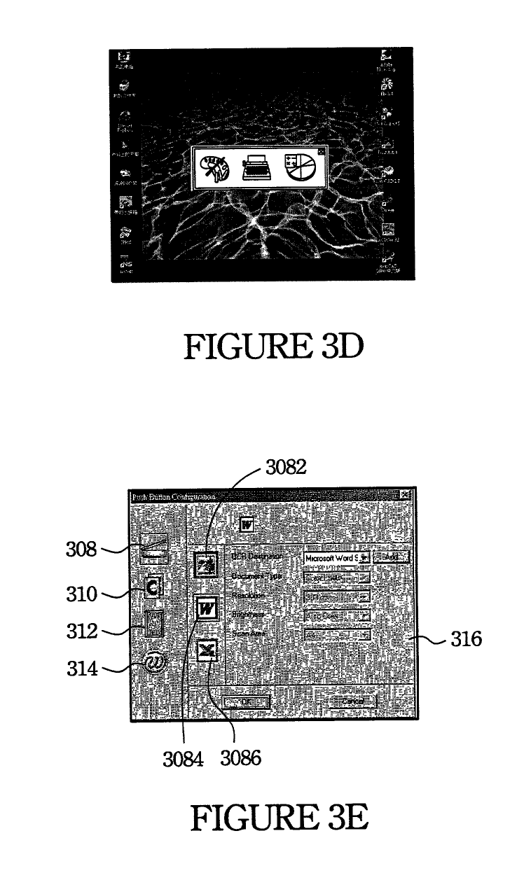

The aforementioned application may be assigned by the computer system (or a default one provided by the computer system), such as text editor Microsoft® Word© or Excel©, or image processing application Imaging©, an application for playing audio or music (i.e., MP3), or applications for translation between different languages. Individual may vary the assigned application via interfaces shown in the computer system provided by the resident module of the scanner or DSC. For example, FIG. 3E illustrates an exemplary graphic interface provided by a scan resident module when individual wishes to assign application for editing. The shown interface provided by FIG. 3E may be activated by pressing left button of a computer mouse at where the icon indicative of the scan resident module being mounted. Four graphic buttons 308, 310, 312, 314 shown in left most side of FIG. 3E are respectively employed for activating operations of scanning copying, faxing, and connecting to the Internet. Additionally, the exemplary graphic interface shown in FIG. 3E also depicts an exemplar when the graphic button 308 being pressed, wherein graphic buttons 3082, 3084, and 3086 are shown for respectively indications to Imaging©, Word© and Excel©, wherein Word© is the currently assigned application. Additionally, individual may select an application to be the assigned one in assignment region 316. The resident module may inquire all mounted applications in the computer system to obtain application lists and then the graphic interface of FIG. 3E will be shown to individual for assigning. As noted, a DSC may provide graphic interfaces similar as the one in FIG. 3E for application assignments. Ordinary persons skilled in the art of the invention should modify the exemplary graphic interfaces such as shown in FIG. 3E of the embodiment as applications, but all similar arrangements or modifications within the spirit of the embodiment should be included in the appended claims. Furthermore, when the SCAN-TO-AP button in the scanner being pressed, a graphic interface depicted in FIG. 3D will be shown provided for individual to perform application assignment, while PaintBrush©, Word©, Excel© are shown in FIG. 3D from left to right. When individual presses SCAN-TO-AP button again, the assign application (e.g., the application assigned in FIG. 3E) will be activated to load those files for editing after format conversion from the images generated from scanners. The skilled persons may also modify the contents and the way of operations of the disclosed graphic interfaces as applications.

As noted, the flowchart in FIG. 4 may be directly employed in scanner, while format conversions to the scanned images are then performed according to requirements of the assigned application, e.g., Microsoft® Word© or Excel©, or Imaging© or PaintBrush© for image processing. For example, when individual wants to load the scanned images into Imaging©, file formats of the scanned images will be converted into bitmap (*.bmp) or JEPG (*.jpg) formats suitable for consecutively editing requirements. When individual loads the scanned images into Word© or Excel© for text editing, an optical character recognition (OCR) may be performed for format conversion to derive text files (*.doc or *.xls) before activating the assigned applications. Additionally, if individual who wants to play a music score by means of MP3 applications, he or she may make the scanned image of the music score to be recognized by means of PhotoScore© of Neuraton® Ltd before playing. Additionally, individual may translate a document sheet by means of Power Translator© of the USA Global Link® company for text translations between different languages after OCR operations to the scanned image of the document sheet.

On the other hand, if the flowchart in FIG. 4 is employed in a DSC, a further step of storing the shot image in DSC should be performed in step 404 because DSC usually departs with the computer system while operating. The stored image is routed to a computer system for performing following functions in steps 406 to 410 for format conversion and information editing, while individual presses the SCAN-TO-AP button in DSC. Format conversion to generate bitmap or JPEG files for loading into Imaging© or PaintBrush©, or to generate *.doc and *.xls files is then performed before loading into Word© or Excel©. Individual may thus press the SCAN-TO-AP button to directly convert file formats of the shot images when DSC couples with the computer system for activating application for editing purpose.

As noted, individual may give a command in the input device of a scanner or DSC to activate the assigned application to load and edit information provided by the shot or scanned images by means of one touch action in the scanner or DSC side. However, any mechanism or device that provides the one touch action may be employed in the embodiment.

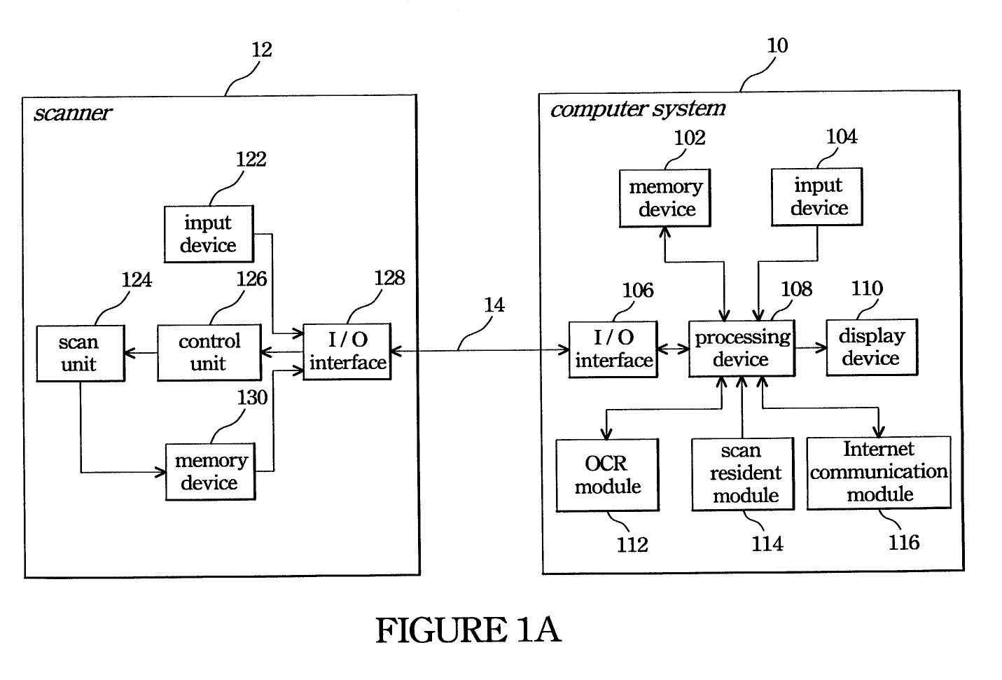

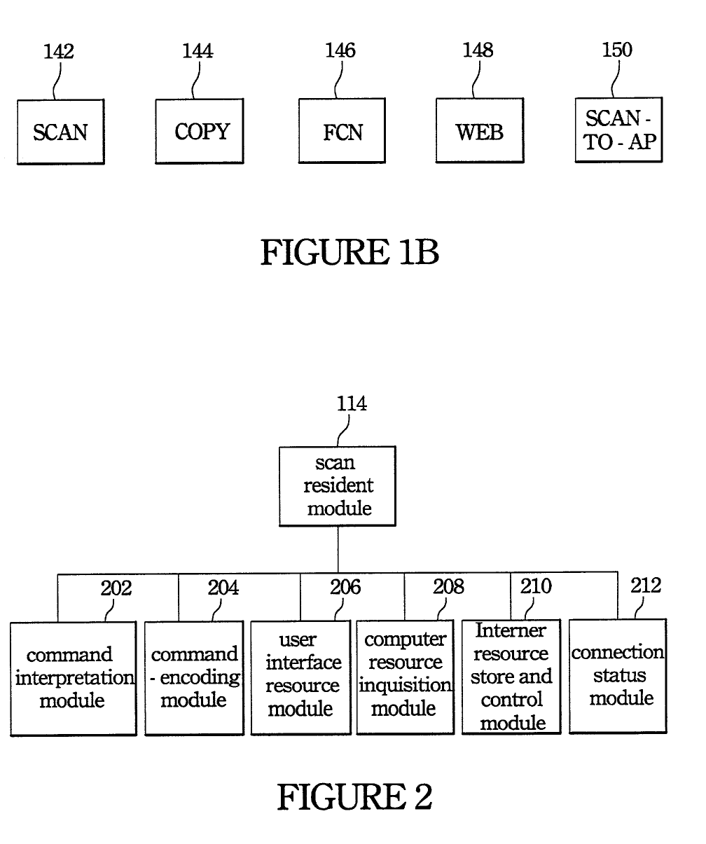

Detailed explanations are given by means of schematic diagrams and associated user graphic interfaces in the following paragraphs. Please firstly refer to FIG. 1A, a scanner schematic diagram of the embodiment is shown therein, however, a DSC may include the similar configuration as the scanner described in the embodiment. The scanner in FIG. 1A basically encompasses computer system 10 and scanner 12 that are coupled together via connection 14. Any wireless or wired communication approach or interface, including TWAIN, SCSI, EPP, or USB (Universal serial bus) may be employed as connection 14 in the embodiment. Please note that computer system 10 may be a personal computer (PC), a workstation, a notebook, or even a palm PC, while scanner 12 may be a roller feeding or flatbed scanner, and the DSC in the embodiment may be any conventional DSC.

Computer system 10 in the embodiment basically encompasses memory device 102, input device 104, I/O interface 106, processing device 108, display device 110, OCR module 112, scan resident module 114, and Internet communication module 116. Processing device 108 couples with memory device 102, input device 104, I/O interface 106, display device 110, OCR module 112, scan resident module 114, and Internet communication module 116 to perform required operations of computer system 10 in the embodiment. Input device 104 and display device 110 are both user interfaces that receives commands from individual and displays information by using optical signals, respectively. Memory device 102 stores information of computer system 10 that is provided for further manipulations by processing device 108. I/O interface 106 couples with scanner 12 for forwarding signals required by scanner 12 or for receiving signals input by individual from scanner 12 that the signals from scanner 12 are routed to processing device 108 for further processing. OCR module 112 stores programs operated by processing device 108 to perform an optical character recognition to the scanned images. Scan resident module 114 stores programs permanent stored in computer system 10 for detecting connection status between computer system 10 and scanner 12, interpreting commands from scanner 12, and real-time displaying interpretation results in display device 110 (more detailed explanations are given for scan resident module 114 later). Internet communication module 116 controls the communications with the Internet such as inputting commands for inquiry information or web sites, or downloading or uploading information.

In the embodiment, scanner 12 basically encompasses input device 122, scan unit 124, control unit 126, I/O interface 128, and memory device 130. Input device 122 receives commands input by individual from scanner 12, while I/O interface 128 couples with I/O interface 106 of computer system 10 for transferring signals mutually. Scan unit 124 is responsive to the commands from control unit 126, while the generated scanned image is stored in memory device 130 before forwarding via I/O interface 128, connection 14 to computer system 10 to wait for manipulations by processing device 108.

Additionally, if scanner 12 is replaced by a DSC, scan unit 124 will be replaced by a picture shooting unit, while the other devices or modules are the same as the ones in FIG. 1A. On the other hand, scan resident module 114 mounted in computer system 10 will be varied by a DSC resident module but performing the similar functions as scan resident module 114.

Input device 122 may be provided as interfaces for receiving commands by employing a configuration in FIG. 1B, which encompasses scan button (SCAN) 142, copy button (COPY) 144, composite button (FCN) 146, Internet communication button (WEB) 148, and a button for scan and then activating associated applications (SCAN-TO-AP) 150. In operations, when individual presses SCAN button 142, the signals indicative of pressing of the SCAN button 142 will be routed to computer system 10 for manipulation. A graphic interface shown in FIG. 3A may be employed to notify individual for giving indications such as confirmations for associated scan parameters (e.g., scan resolution) while scanning, or enabling the scan operation via the shown graphic interface. A confirmation command input via the graphic interface (may be input via the same button in scanner 12 by pressing it again) will be forwarded to scanner 12 for scanning document sheets. Additionally, when individual presses COPY button 144, the signals indicative of COPY button 144 being pressed will be routed to computer system 10 for manipulations so that a graphic interface in FIG. 3B may be shown to individual. The scanned images of the document sheets are then derived after a confirmation command for copying scanned document sheets being input from individual. Similarly, when individual presses WEB button 148, the button pressed signals will be routed to computer system 10 for manipulations. Computer system 10 will connect with the indicated web sites before deriving the scanned images for uploading. Additionally, when individual presses the FCN button 146, the button pressed signals will be routed to computer system 10 for manipulations. A graphic interface in FIG. 3C including graphic buttons 302, 304, and 306 respectively for activating functions of mailing (MAIL), faxing (FAX), and scanning and then loading by associated applications (SCAN-TO-AP) will be shown in display device 110 of computer system 10. Additionally, the functions associated with SCAN-TO-WEB button may refer to the reference application entitled “Apparatus and method for directly uploading scanned images to associated web sites” having the same Applicants with the present invention. However, another invention with the same Applicant entitled “Input apparatus and method of scanners having composite buttons for enabling functions” can be a cross-reference article of the invention for giving descriptions to FCN button 146.

Furthermore, if the embodiment is employed in a DSC, a specific button having the aforementioned function provided by SCAN-TO-AP button 150 may be mounted in DSC. Operating sequences shown in FIG. 4 may thus be activated when individual presses the button.

As noted, the aforementioned input device 104 of computer system 10 may be any kind of input interface, such as keyboard, mouse, or track ball, while input device 122 of scanner 12 may encompass at least one button or any mechanism for enabling so-called “one touch” action. Display device 110 may be a CRT or LCD system in the embodiment. Moreover, processing device 108 may be CPUs or microprocessors broadly employed in modern computer systems, while control unit 126 also can be mounted by means of microprocessors. Memory device 102 or 130 may be mounted by using DRAM, SRAM, or flash memory, etc, while OCR module 112, scan resident module 114, and Internet communication module 116 may be stored in computer-readable storage media such as hard disks. The aforementioned I/O interfaces 106 and 128 may be mounted according to practically employed interface for the connection 14, while scan unit 124 may be any mechanism or device for scanning document sheets. An ordinary person skilled in the art of the invention may modify the embodiment as applications. Additionally, conventionally CCD or CMOS sensor may be employed in a DSC for shooting pictures in the embodiment, while the CCD, CMOS sensor, or even CIS may be employed in scanner 12 for picking up images of the document sheet.

Please next refer to FIG. 2, a detailed configuration illustrative of scan resident module 114 is shown for giving more explanations. Basically, scan resident module 114 encompasses command interpretation module 202, command-encoding module 204, used interface resource module 206, computer resource inquisition module 208, Internet resource store and control module 210, and connection status detection module 212. Command interpretation module 202 stores programs provided for processing device 108 of computer system 10 to perform the operations of interpreting commands input from scanner 12 or computer system 10. Command-encoding module 204 stores programs provided for computer system 10 to perform operations of encoding commands in computer system 10 for further forwarding to scanner 12 to enable scan operation via connection 14, or to transfer the scanned image to computer system 10. User interface resource module 206 stores codes associated with graphics or icons required by the graphic interfaces shown in display device 110. Computer resource inquisition module 208 stores programs provided for computer system 10 to perform operations of inquiring the currently mounted applications of computer system 10. Internet resource store and control module 210 stores codes associated with web sites indicated by individual. Connection status detection module 212 stores programs provided for computer system 10 to perform operations of monitoring connection 14 between scanner 12 and computer system 10. Associated operations will be performed when processing device 108 of computer system 10 operates the programs or codes provided by the aforementioned modules. As noted, the aforementioned modules may be stored in any computer-readable and portable storage medium, e.g., a compact disc (CD), floppy disk, or magnetic optical (MO) disk, which is further accessed and operated by processing device 108. However, the programs or codes of the above modules may be stored in hard disks of computer system 10 for performing associated operations while scanner 12 activating. Notably, the similar functions that are provided by scan resident module 114 may be included in the aforementioned DSC resident module if the embodiment is used to a DSC.

Please note that FCN button 146 may be employed to include the SCAN-TO-AP function of the embodiment, while individual also applies so-called one touch action to activate associated SCAN-TO-AP function in scanner 12 or DSC side. However, a graphic such as the one of FIG. 3C may be employed in computer system 10 to wait for further indications from SCAN-TO-AP graphic button when individual presses FCN button 146. An ordinary person skilled in the art of the invention should modify the embodiment as his or her requirements or applications but all similar modifications within the spirits of the embodiment should be encompassed in the appended claims.

As is understood by a person skilled in the art, the foregoing preferred embodiments of the present invention are illustrated of the present invention rather than limiting of the present invention. It is intended to cover various modifications and similar arrangements, such as mounting the functions of converting image formats and then activating associated application into a composite button or a generic button, included within the spirit and scope of the appended claims, the scope of which should be accorded the broadest interpretation so as to encompass all such modifications and similar structure.

What is claimed is:

1. An image generation apparatus, a format conversion being performed to an image generated by said apparatus before activating an application mounted in a computer system coupled with said apparatus for editing information provided by said image, wherein said apparatus comprises:
image pick-up means for generating an images; and
input means responsive to a command according to one touch action for activating said image pick-up means for generating said image;
wherein said computer system performs said format conversion to said generated image and activates an assigned application to load said converted file derived from said format conversion for editing information provided by said generated image.

2. The apparatus according to claim 1, wherein said input means comprises a button.

3. The apparatus according to claim 1, wherein said image pick-up means is mounted in a scanner or a digital still camera.

4. The apparatus according to claim 1, wherein said assigned application comprises a text editor, an application for performing image processing or editing, an application for playing audio or music, or an application for translation between different languages.

5. The apparatus according to claim 4, wherein an optical character recognition is performed before said text editor being activated.

6. A method for converting image formats before activating an application mounted in a computer system for editing information provided by said image, wherein said method comprises the steps of:
generating an image in an apparatus activated by using one touch action;
performing a format conversion to said image according to a requirement of an assigned application; and
activating said assigned application to load a file of said image for editing after format conversion.

7. The method according to claim 6, wherein said apparatus comprises a scanner or a digital still camera.

8. The method according to claim 6, wherein application comprises a text editor, an application for performing image processing or editing, an application for playing audio or music, or an application for translation between different languages.

9. The method according to claim 8, wherein an optical character recognition is performed before said text editor being activated.

10. A computer system, which couples with an apparatus for generating images according to one touch action, for activating an assigned application after format conversions being performed to said images, wherein said computer system comprises:
at least one application, wherein one of said application is assigned to load a file of an image generated by said apparatus after a format conversion;
a storage device; and
a processing means coupled with said storage device for operating programs codes provided by said storage device to
interpret a command input from said apparatus;
perform said format conversion to said generated image according to a requirement of said assigned application; and
activate said assigned application to load said converted file of said generated image after format conversion for editing information provided by said generated image.

11. The computer system according to claim 10, wherein said storage comprises:
a command interpretation module for storing program codes operated by said processing device for interpreting said command input from said apparatus or said computer system, wherein said computer system is responsive to said interpreted command for conversion format of said generated image and to load said file after format conversion for editing;
a user interface resource module for storing resource codes of graphic interfaces shown in said computer system; and
a computer resource inquisition module for storing programs operated by said processing device for inquiring applications mounted in said computer system.

12. The computer system according to claim 11, wherein said graphic interfaces comprise at least one composite input mechanism for activating at least one function at said computer system.

13. The computer system according to claim 10, wherein said user interface resource module comprises program codes operated by said processing device for varying said assigned application.

14. The computer system according to claim 10, wherein said assigned application comprises a text editor, an application for performing image processing or editing, an application for playing audio or music, or an application for translation between different languages.

15. The computer system according to claim 14, wherein an optical character recognition is performed before said text editor being activated.
